(19) United States
(12) Patent Application Publication
(10) Pub. No.: US 2006/0254152 A1
(43) Pub. Date: Nov. 16, 2006

(54) Sliding metal shutter for window openings

(76) Inventor: Guillermo Manuel Castillo, Spring Hill, FL (US)

Correspondence Address: Guillermo Castillo, 3378 Susan Drive, Spring Hill, FL, 34606, US

(21) Appl. No.: 11/029,259

(22) Filed: May 13, 2005

(51) Int. Cl. E06B 3/32

(52) U.S. Cl. 49/463

(57) ABSTRACT

The metal shutter is a metal device attached to the existing protruding window frame by bending in the side edges of a sheet of metal. The side bent edges slide over the track frame and at the same time provides a secure grip to the existing metal frame. The top side of the metal shutter is also bent so as to rest and grip over the top track frame of the window. The bottom side of the metal shutter is not bent as to provide free up and down movement. No additional hardware is needed to hold and support the Sliding Metal Shutter. The width and length of the sliding metal shutter varies according to the window frame opening.

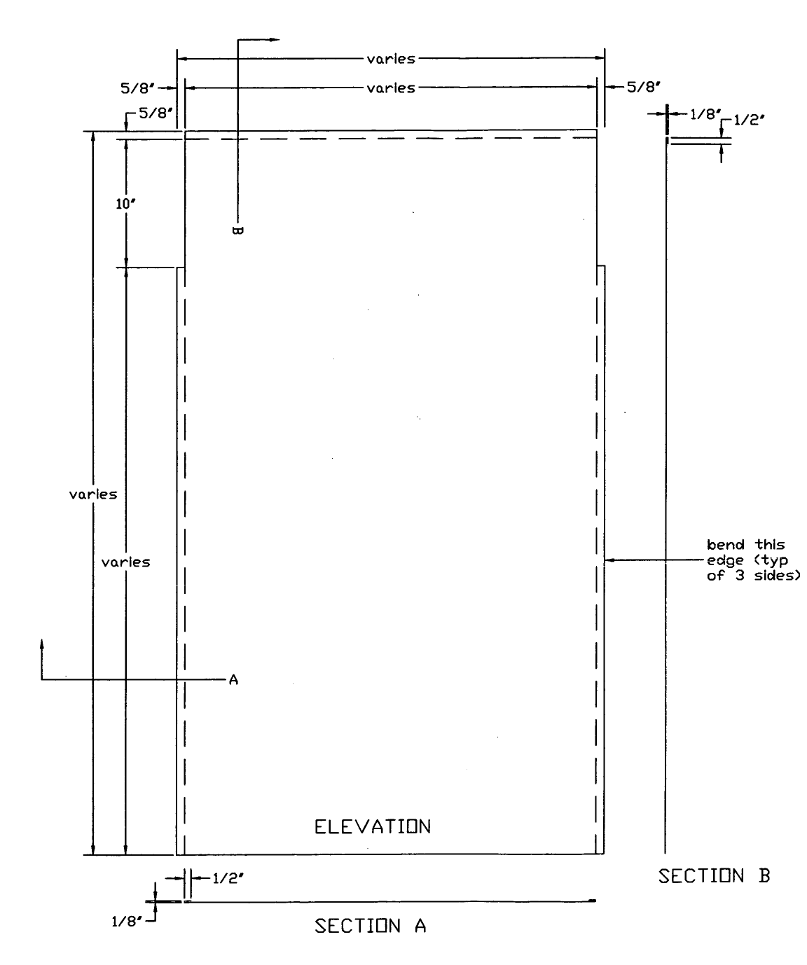

The way the metal shutter operates is by sliding up and down over a track. This is achieved by bending in the side edges of sheet of metal and the track is the existing protruding window frame.

The side bent edges slide over the track frame and at the same time provide a secure grip to the existing metal frame. The top side of the metal shutter is also bent so as to rest and grip over the top track frame of the window. The bottom side of the metal shutter is not bent as to provide free up and down movement. No additional hardware is needed to hold and support the Sliding Metal Shutter. The width and length of the sliding metal shutter varies according to the window frame opening. Various types of metal can be used for the above description

I claim that my shutter:

1. Will protect window opening from wind pressure and from small yard debris as a result of hurricane activity

2. Can be installed without any tools as long as they are but into mobile home window frame
